(19) United States
(12) Patent Application Publication
(10) Pub. No.: US 2002/0140685 A1
(43) Pub. Date: Oct. 3, 2002

(54) Display control apparatus and method

(76) Inventors: Hiroyuki Yamamoto, Tokyo (JP); Nobuyuki Hirano, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/940,658

(22) Filed: Aug. 29, 2001

(30) Foreign Application Priority Data
Mar. 27, 2001 (JP) 2001-089071

(51) Int. Cl. G09G 5/00

(52) U.S. Cl. 345/204

(57) ABSTRACT

A display control apparatus, which refreshes image data in a frame memory of a display panel with a memory function, includes a compare unit for comparing the image data in a previous frame and the image data in a current frame at a specific line in the display panel, a data transmission unit for transmitting the image data in the current frame at the specific line in order to update the image data when the compare unit outputs inconsistency at the specific line as the comparing result and for transmitting hold information when the compare unit outputs consistency at the specific line, and a display panel drive control unit for synchronously giving an instruction of refreshing with the transmitting of the data transmission unit.

### BACKGROUND OF THE INVENTION

1. Field of the Invention

The present invention relates to an image data display control apparatus for mobile equipment, specially relates to power saving and high speed control of image display apparatus whose element has a pixel size memory function.

2. Description of the Related Art

In a conventional display control apparatus, the display apparatus itself does not have a memory function, but has a frame memory for storing display images per frame. Therefore, images in the frame memory are scanned at refresh cycles and transmitted to the display apparatus.

In the case of liquid crystal panel being used as a display apparatus, the liquid crystal panel side has a frame memory, and image information equivalent to one frame is transmitted from the control apparatus side. In transmitting the image information equivalent to one frame, some invention has been conventionally contrived in order to decrease the data amount written into the frame memory at the liquid crystal panel side, which speeds the operation and performs the power saving.

FIG. 19 shows the configuration of liquid crystal display control apparatus, in which high rate scrolling operation can be performed, disclosed in Unexamined Japanese Patent Publication No. 9-265274.

The apparatus of FIG. 19 includes the following elements: a data driver 304 is provided with scroll display amount retaining means, a display address counter for shifting a display address corresponding to a scroll display amount, and address converting means. A shift register 342 which shifts data equivalent to one line of display memory in the data driver 304 in accordance with the scroll display amount, and writes the data into the display memory and a data selector 340 are also provided. In the case of a lateral direction scroll display, the shift register 342 shifts image data of one line.

As stated above, since the scroll display amount retaining means, the display address counter for shifting a display address corresponding to a scroll display amount, and the address converting means are provided in the data driver according to the conventional apparatus, only addresses are changed for giving instructions in the case of a vertical direction scroll display, instead of all the image data of display memory in the data driver being updated. Then, the liquid crystal panel directly writes images to the addresses having been newly changed. Therefore, as the data transmission cycle is lessened, scrolling can be performed at high speed and the power saving can be realized.

Since the shift register for writing data equivalent to one line of display memory into the display memory in accordance with the scroll display amount and the data selector are also provided in the data driver, and the same address change as the above is directed, it is not necessary to update all the image data of one line by the shift register display memory in the case of lateral direction scroll display. Therefore, as the data transmission cycle is lessened, scrolling can be performed at high speed and the power saving can be realized.

Besides, control means is provided for the display memory in each of the two data drivers. Commonly using an address bus and a data bus at the same time, the control means performs controlling a read operation for one display memory and a write operation for the other display memory. Accordingly, during a scroll display, it is possible to transmit image data between the display memories. Then, as data transmission cycle is lessened, scrolling can be performed at high speed and the power saving can be realized.

As stated above, the image information transmission to the display apparatus at high speed has been contrived in the conventional display control apparatus. However, control over the display apparatus itself has not been contrived. Concretely, no invention for refreshing, in relation to the power saving, has been disclosed. In addition, an effective use of the time during no refreshing has not been disclosed.

One of the objects of the present invention is to solve the above problem. Mainly, it is aimed to save the power consumption by way of contriving the refreshing.

### SUMMARY OF THE INVENTION

According to one aspect of the present invention, a display control apparatus, which refreshes image data in a frame memory of a display panel with a memory function, comprises:

a compare unit for comparing the image data in a previous frame and the image data in a current frame at a specific line in the display panel;

a data transmission unit for transmitting the image data in the current frame at the specific line in order to update the image data when the compare unit outputs inconsistency at the specific line as a comparing result, and for transmitting hold information when the compare unit outputs consistency at the specific line; and

a display panel drive control unit for synchronously giving an instruction of refreshing (display writing) with the transmitting of the data transmission unit,

wherein the display panel performs refreshing by the instruction from the display panel drive control unit based on the image data from the data transmission unit.

According to another aspect of the present invention, a display control method, for refreshing image data in a frame memory of a display panel with a memory function, comprises:

comparing the image data in a previous frame and the image data in a current frame at a specific line in the display panel;

transmitting the image data in the current frame at the specific line in order to update the image data when the comparing results in inconsistency at the specific line, and transmitting hold information when the comparing results in consistency at the specific line; and

synchronously giving an instruction of refreshing (display writing) with the transmitting the image data,

wherein the display panel performs refreshing the image data in the transmitting, based on the instruction.

The above-mentioned and other objects, features, and advantages of the present invention will be made more apparent by reference to the following detailed description when taken in conjunction with the accompanying drawings.

### BRIEF DESCRIPTION OF THE DRAWINGS

In the drawings,

FIG. 1 shows a display control apparatus according to Embodiment 1 of the present invention;

FIG. 2 shows a detailed configuration of a display panel with a memory function according to the present invention;

FIG. 3 illustrates a panel display example for explaining operations of the display control apparatus according to Embodiment 1;

FIG. 4 shows another display control apparatus according to Embodiment 1;

FIG. 5 illustrates a panel display example for explaining operations of the display control apparatus shown in FIG. 4;

FIG. 6 shows another display control apparatus according to Embodiment 1;

FIG. 7 illustrates a panel display example for explaining operations of the display control apparatus shown in FIG. 6;

FIG. 8 shows another display control apparatus according to Embodiment 1;

FIG. 9 illustrates a panel display example for explaining operations of the display control apparatus shown in FIG. 8;

FIG. 10 shows a display control apparatus according to Embodiment 2 of the present invention;

FIG. 11 shows a detailed configuration of a display panel with a memory function according to Embodiment 2;

FIG. 12 illustrates operations of the display control apparatus according to Embodiment 2;

FIG. 13 illustrates operations of the display control apparatus according to Embodiment 2;

FIG. 14 shows a display control apparatus according to Embodiment 3 of the present invention;

FIG. 15 illustrates operations of the counter in the refresh control unit shown in FIG. 14;

FIG. 16 shows a panel display example for explaining operations of the display control apparatus according to Embodiment 3;

FIG. 17 shows a display control apparatus according to Embodiment 4 of the present invention;

FIG. 18 illustrates a timing chart for showing operations of the refresh control unit in FIG. 17; and

FIG. 19 shows a configuration of a conventional liquid crystal display control apparatus.

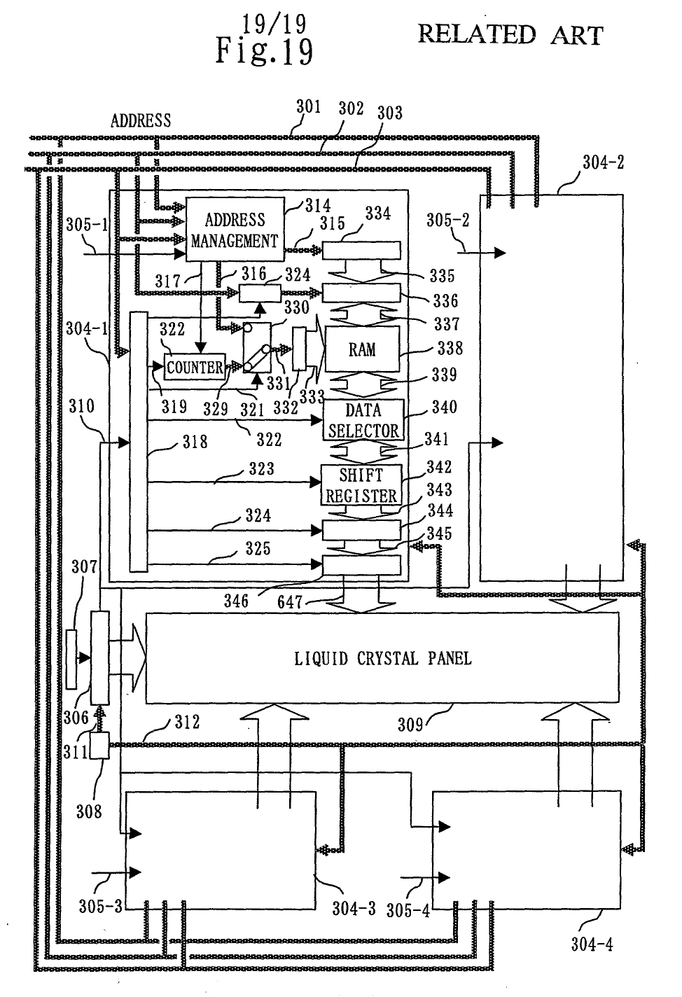

### DETAILED DESCRIPTION OF PREFERRED EMBODIMENTS

Embodiment 1.

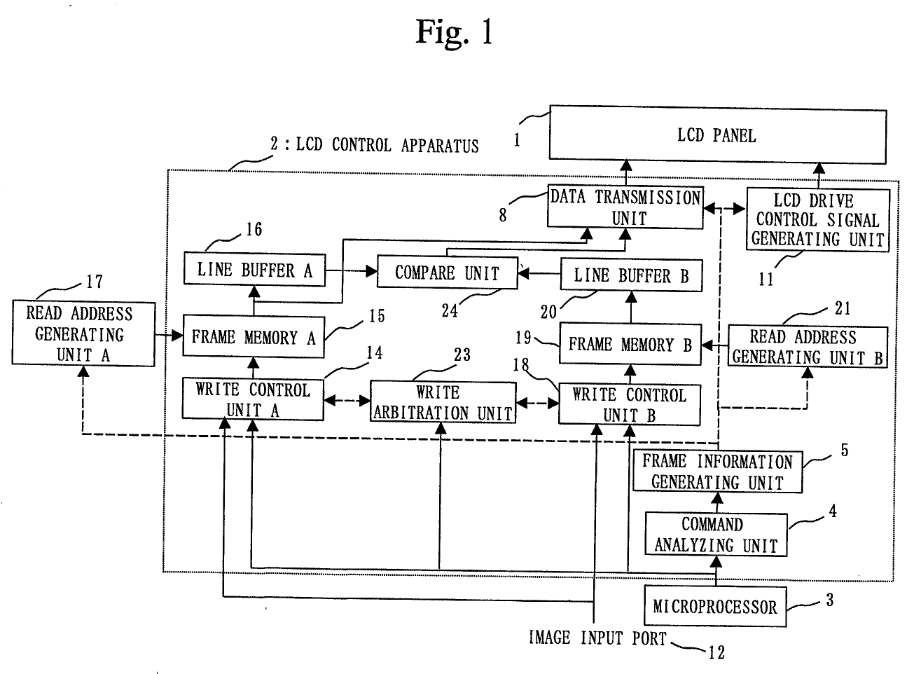

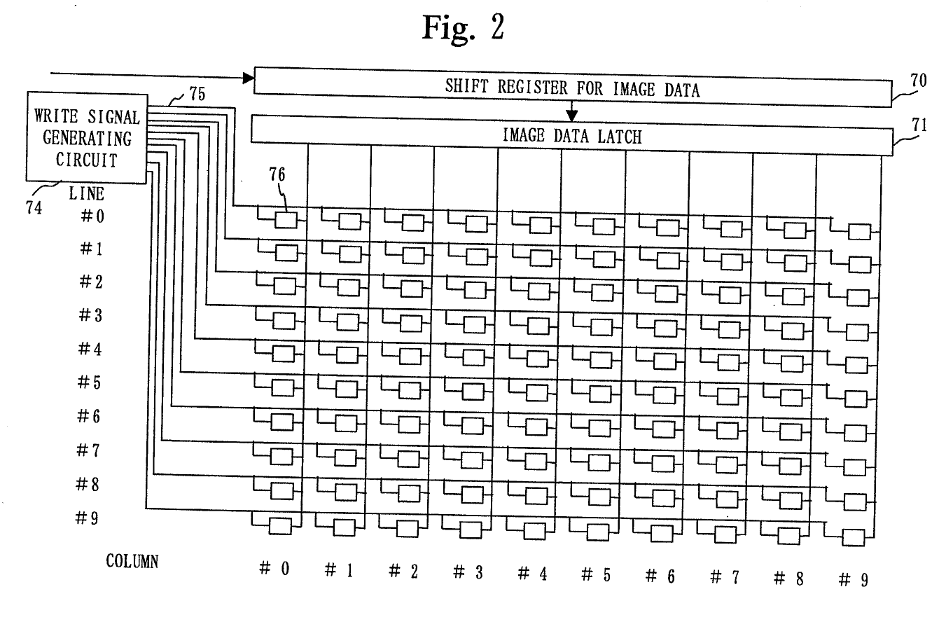

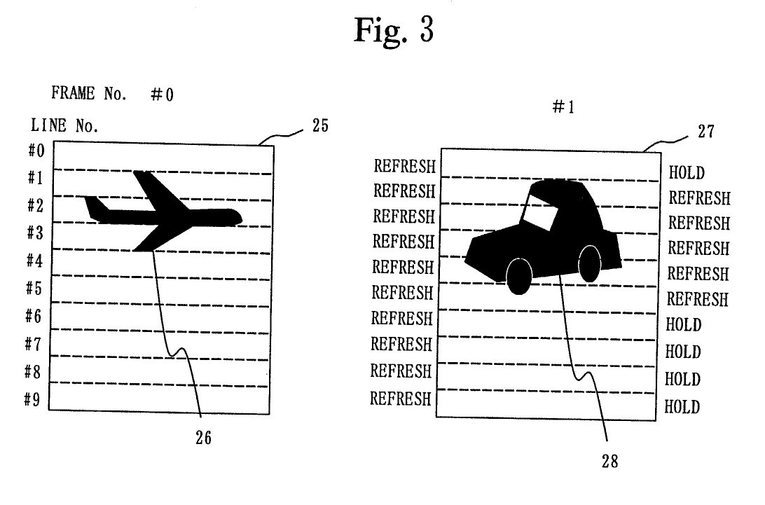

FIG. 1 shows a configuration of display control apparatus according to the present Embodiment. FIG. 2 shows a configuration of display panel with a memory function, and FIG. 3 illustrates a panel display example for explaining operations of the display control apparatus according to the present Embodiment. The point of this embodiment is to save the power consumption by way of contriving the writing into a display panel with a memory function.

First, display panel operations will be explained with reference to FIG. 2. Image data equivalent to one line is serially input into a shift register 70 for image data. After all the image data equivalent to one line has been input into the shift register 70 for image data, the image data is once latched in an image data latch 71. Then, the image data is written into pixel memories 76 arranged in the LCD panel like a matrix, by write-enable signals 75 per line generated in a write signal generating circuit 74. This processing is performed for all the lines of the image data.

After writing the image data into the pixel memories, the image data can be retained in a specific period. To rewrite the image data is called “refresh” and to retain the image data is called “hold” hereinafter. A cycle for periodically updating images is called a “refresh cycle”.

Now, the configuration in FIG. 1 will be described. The following are provided in FIG. 1: a display panel (LCD panel) I having a memory function, an LCD control apparatus 2, a microprocessor 3, a command analyzing unit 4, a frame information generating unit 5, a data transmission unit 8 for converting image data to be in accordance with a data format accepted by the LCD panel and transmitting the converted data to the LCD, an LCD drive control signal generating unit 11, an image input port 12 for transmitting image data come from the outside, a write control unit A 14 for controlling the writing image data into the frame memory from the image input port, a frame memory A 15 for storing image data equivalent to one screen, a line buffer A 16 for storing image data equivalent to one line, a read address generating unit A 17 for specifying a read address for the frame memory, a write control unit B 18, a frame memory B 19, a line buffer B 20, a read address generating unit B 21, a write arbitration unit 23 for arbitrating the image data to be written into the frame memory A 15 and the frame memory B 19, and a compare unit 24 for comparing a buffer image data of the line buffer A 16 and that of the line buffer B 20.

Now, the operation of the display control apparatus according to the present Embodiment will be explained with reference to FIGS. 1 and 3. FIG. 3 shows a frame just after having started to display image data in the LCD panel 1. Namely, the image data is written into all the lines from #0 to #9 in #0 frame 25 of FIG. 3. In other words, the image data is refreshed. In FIG. 1, the above operation indicates that the image data equivalent to one screen (one frame) is written into the frame memory A 15 by the write control unit A 14 via the microprocessor 3 or the image input port 12. An address for the frame memory A 15 is generated in the read address generating unit A 17, and image data is read and transmitted to the data transmission unit 8. Then, the data transmission unit 8 converts the image data to be in accordance with the data format of the LCD panel 1 and transmits the converted image data to the LCD panel 1. Receiving the converted image data, the LCD panel 1 updates (refreshes) the image data along the line direction.

Next, the image data of the second frame is written into the frame memory B 19 by the write control unit B 18 via the microprocessor 3 or the image input port 12. The write arbitration unit 23 controls the image data to be alternately written into the two frame memories and not to be written into the next frame while the frame memory is being read.

At #1 frame 27 of FIG. 3, the image data of the lines from #1 to #5 has been changed. Regarding the other lines, it is not necessary to update the image because they show the same background. The image data equivalent to one line stored in each of the frame memory A 15 and the frame memory B 19 is respectively read into the line buffer A 16 and the line buffer B 20 in order to be compared per line. The compare unit 24 compares the image data at each line and judges whether there is inconsistency or not per line. If there is inconsistency, information of the inconsistent line is transmitted to the data transmission unit 8. Then, the line information is converted to the data transmission form of the LCD panel 1 and the converted image data of one line is transmitted to the LCD panel 1. The LCD panel 1 refreshes pixel memories corresponding to the received line, and switches the display. Based on the instruction from the LCD drive control signal generating unit 11, the write signal generating circuit 74 in the LCD panel 1 skips writing into lines which have not received the image data. Therefore, the previous frame information having been retained in the pixel memory of the LCD panel 1 is still displayed.

Repeating the above processing, the display in the LCD panel 1 is executed. By dint of the processing, it becomes possible to refresh only the lines whose images have been updated. Consequently, data transmission between the LCD control apparatus 2 and the LCD panel 1 can be reduced and the power consumed in the output buffer of the LCD control apparatus 2 can be suppressed. Regarding the pixel memories of the LCD panel 1, it is enough to refresh only the pixel memories corresponding to the line whose image data has been updated. Therefore, the power consumption used for the refreshing can be suppressed.

The method of scanning in the direction of the line has been explained in the present Embodiment. It is also acceptable to scan in the direction of the column based on the same configuration. If the same elements are provided and the same operation is performed in the case of scanning along the column, the LCD display, where nothing is written into the LCD during the “hold” and image data is retained during the “hold”, can be realized.

Another example of Embodiment 1 where only lines having differences, compared between frames, are controlled to be written into the LCD will be explained.

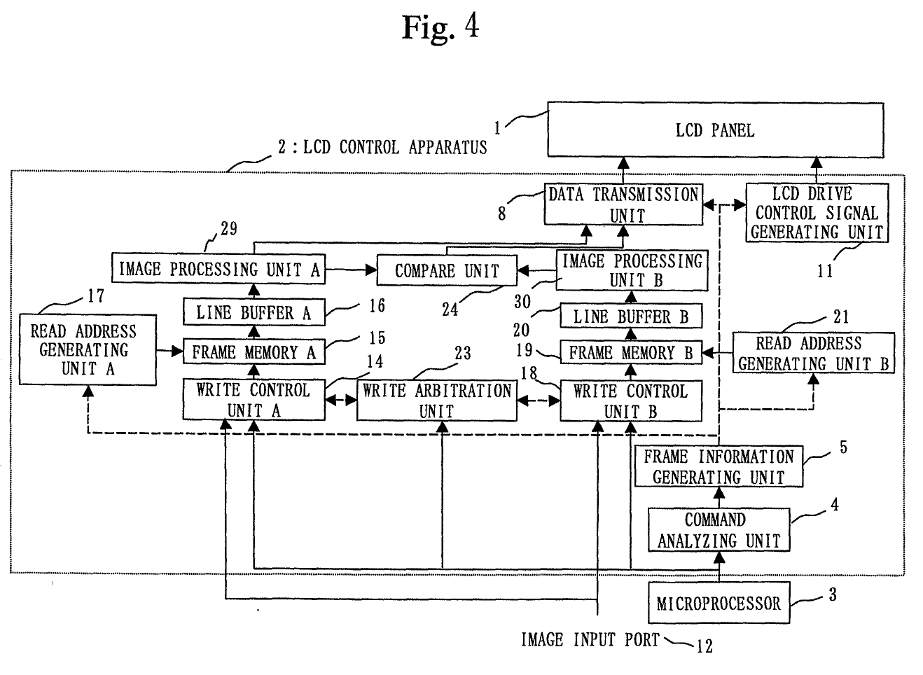

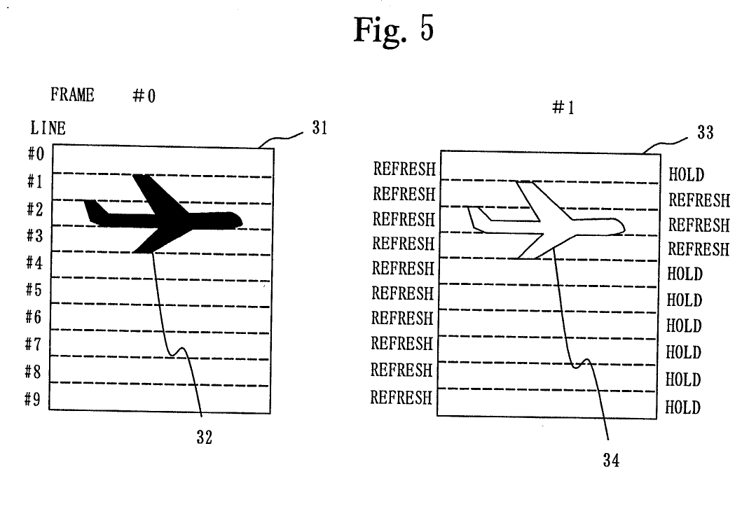

FIG. 4 shows a configuration of another display control apparatus according to the present Embodiment. An image processing unit A 29 and an image processing unit B 30 for performing an image process such as filtering, gray scale value transforming, representing in binary digits, or border (outline) emphasizing, for the image data are provided in FIG. 4 as new configuration elements. The other elements indicate the same as those having the same numbers in FIG. 1. The compare unit 24 compares outputs from each image processing unit per line. FIG. 5 shows a panel display example for explaining the operation of the apparatus in FIG. 4. The color of the airplane at the lines from #1 to #3 has been changed by the image process is shown in FIG. 5. In this case, the image data equivalent to one line corresponds to the data having been processed by the image processing unit.

The operation will be explained below. Comparing the #0 frame 31 processed by the image processing unit A 29 and the #1 frame 33 processed by the image processing unit B 30, only the part of the lines from #1 to #3 is different. Therefore, a write instruction indicating that only the part of the lines from #1 to #3 should be written is given to the LCD panel 1. Accordingly, the image data transmission amount to the LCD panel 1 and the write amount into the LCD panel 1 are reduced, which realizes the power saving. It is also acceptable to scan in the direction of column while the display control apparatus has elements for scanning along the column, instead of the direction of line (row).

The case of contents of image data at the refresh part being changed or processed has been explained in the above. Also, the scrolling display case or zooming display case can be acceptable. Now, the configuration and the operation of scrolling display case or zooming display case will be described.

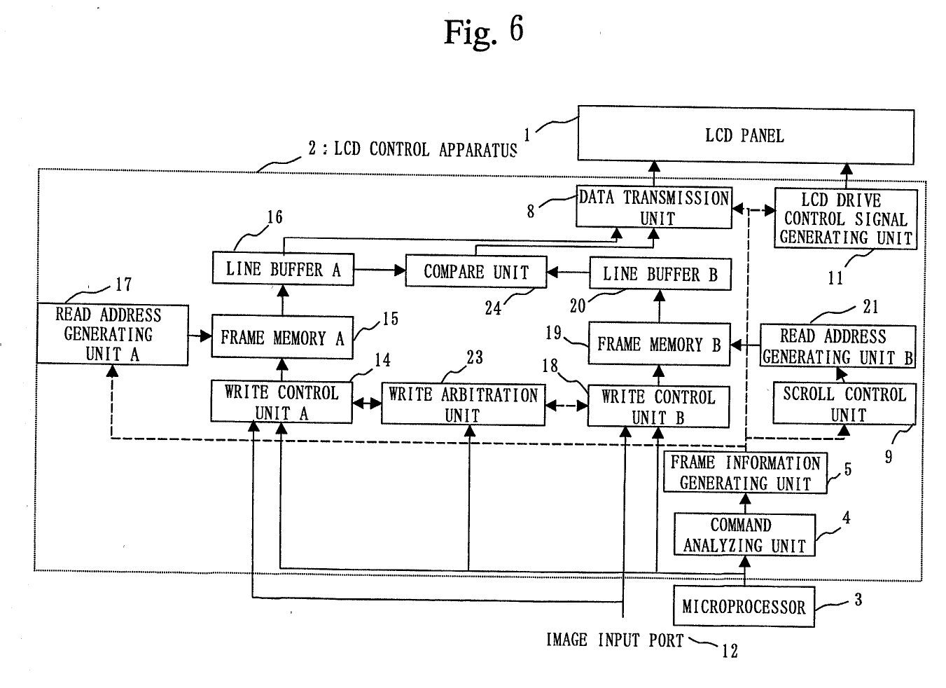

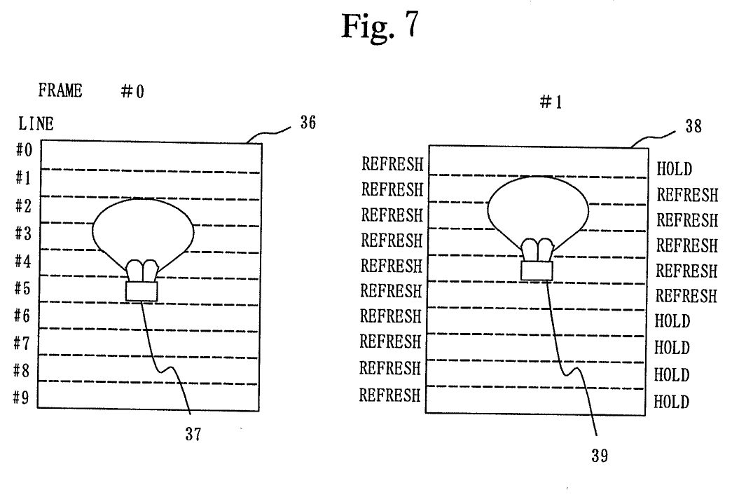

FIG. 6 shows a configuration of another display control apparatus according to the present Embodiment. A scroll control unit 9 for calculating a value of memory address corresponding to a scroll instruction via the microprocessor is provided as a new configuration element. The other elements are the same as those having been explained. FIG. 7 shows a panel display example explaining the operation of the apparatus in FIG. 6. In FIG. 7, comparing the balloon locations of the prior-screen and the posterior-screen, the location has been moved to the upper to be at the lines from #1 to #4.

The operation will now be explained. In the conventional scroll operation, image data in the memory is firstly converted to the screen form of after scrolling and the converted image data is transmitted to the display panel. In the present Embodiment, receiving a scroll instruction, the scroll control unit 9 directly calculates an address, conveys the address to the read address generating unit, reads image data of the line corresponding to the address from the frame memory via the line buffer, and transmits the image data to the data transmission unit 8, without performing the troublesome and time consuming operations of the conventional method. Since the other operations have been described in the above, the explanation for them is herein omitted.

In this case, no image data is rewritten into the memory at the refreshing control for the scroll display, and only a read address is changed. Accordingly, the time and the energy can be saved. In addition, since the hold control is also performed, the power consumption can be suppressed.

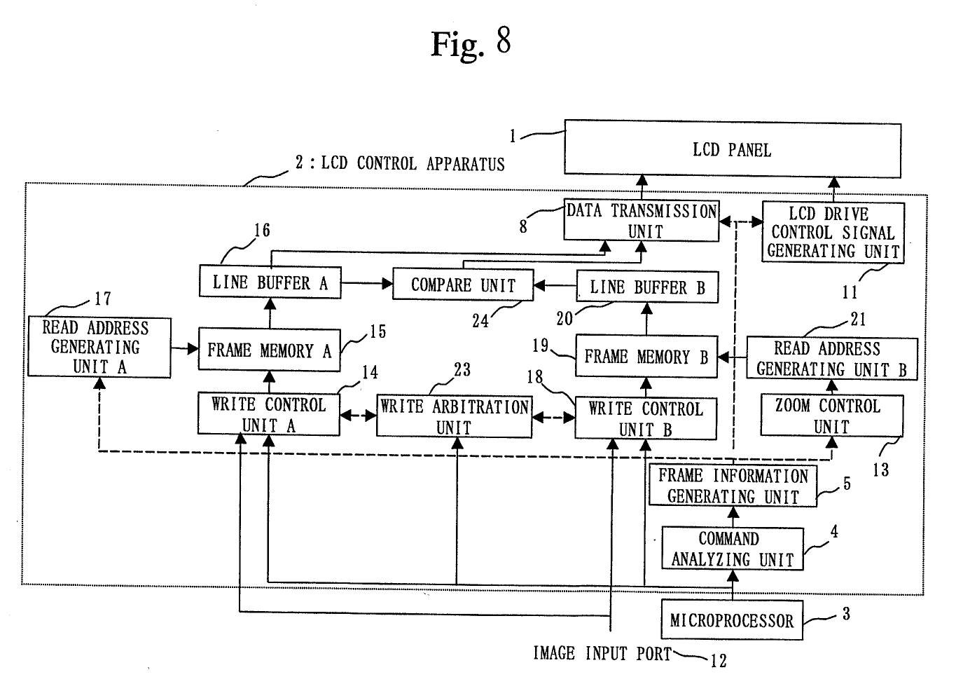

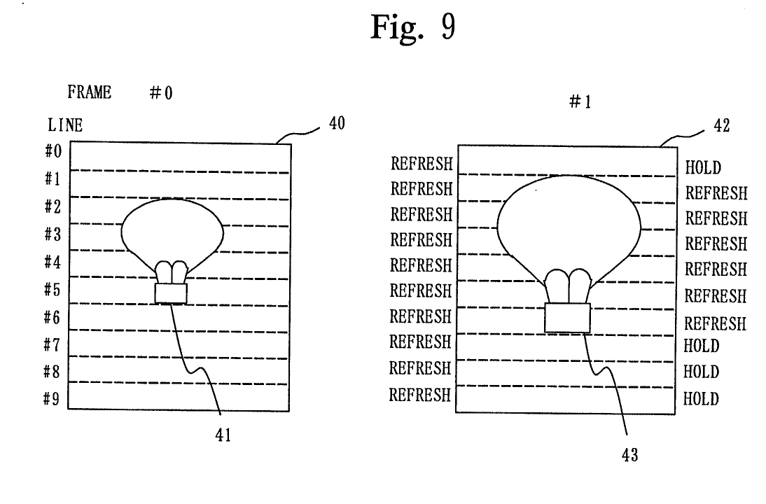

The configuration and operation of zooming display case will now be explained. FIG. 8 shows a configuration of another display control apparatus according to the present Embodiment. A zoom control unit 13 for calculating a value of memory address corresponding to an image zoom instruction sent via the microprocessor is provided as a new configuration element. The other elements are the same as those having been explained. FIG. 9 shows a panel display example for explaining the operation of the apparatus in FIG. 8. In FIG. 9, comparing the balloon sizes of the prior-screen and the posterior-screen, the size has been enlarged at the lines from #1 to #6.

The operation will be explained. In the conventional zoom operation, image data in the memory is firstly converted to the screen form of after zooming and the converted image data is transmitted to the display panel. In the present Embodiment, receiving a zoom instruction, the zoom control unit 13 directly calculates an address, conveys the address to the read address generating unit, reads the image data of the line corresponding to the address from the frame memory via the line buffer, and transmits the image data to the data transmission unit 8, without performing the troublesome and time consuming operations of the conventional method. The other operations are the same as those having been described above. In this case, no image data is rewritten into the memory at the refreshing control. Accordingly, the time and the energy can be saved, which realizes the speed up and the power saving at the holding.

According to the present Embodiment 1, the comparing is performed per line or column in order to find inconsistency. If there is no inconsistency, holding is performed. Therefore, the writing into the display panel can be lessened, which has an effect of reducing the power consumption.

Embodiment 2.

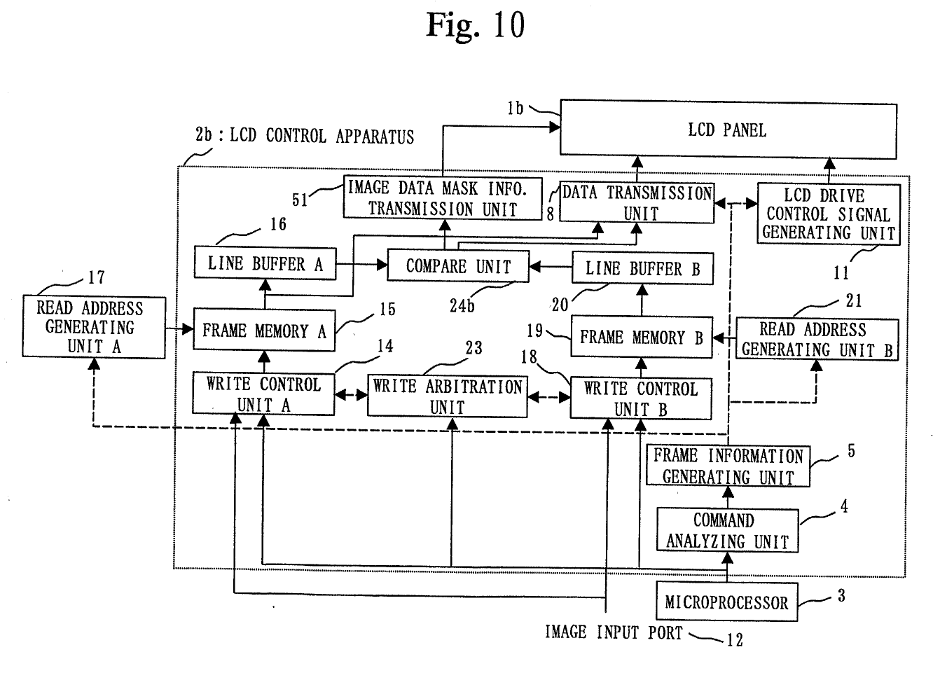

The configuration for increasing the occasions of holding by further subdividing the holding part will now be explained. FIG. 10 shows a configuration of a display control apparatus 2b according to the present Embodiment. Comparing Embodiment 1, a transmission unit 51 for image data mask information is provided as a new configuration element in FIG. 10. A compare unit 24b transmits a comparison result of each pixel to the transmission unit 51 for image data mask information.

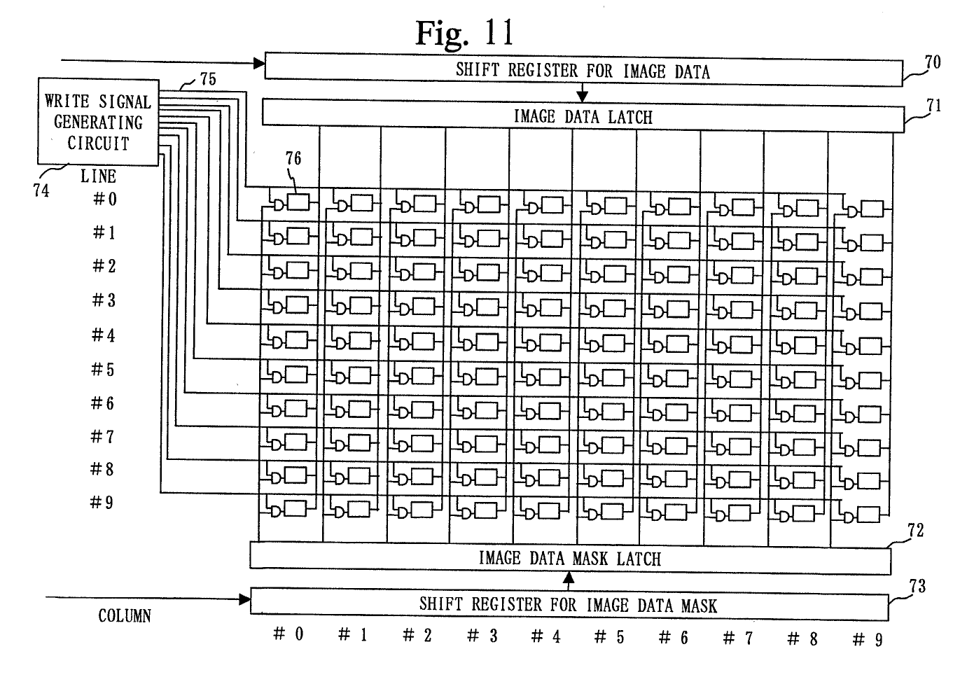

FIG. 11 shows a configuration of a display panel 1b including the pixel memory 76 with a memory function according to the present Embodiment. Comparing with FIG. 2, an image data mask latch 72, a shift register 73 for image data mask, and an AND element used for writing into the pixel memory 76 at each pixel are added in FIG. 11.

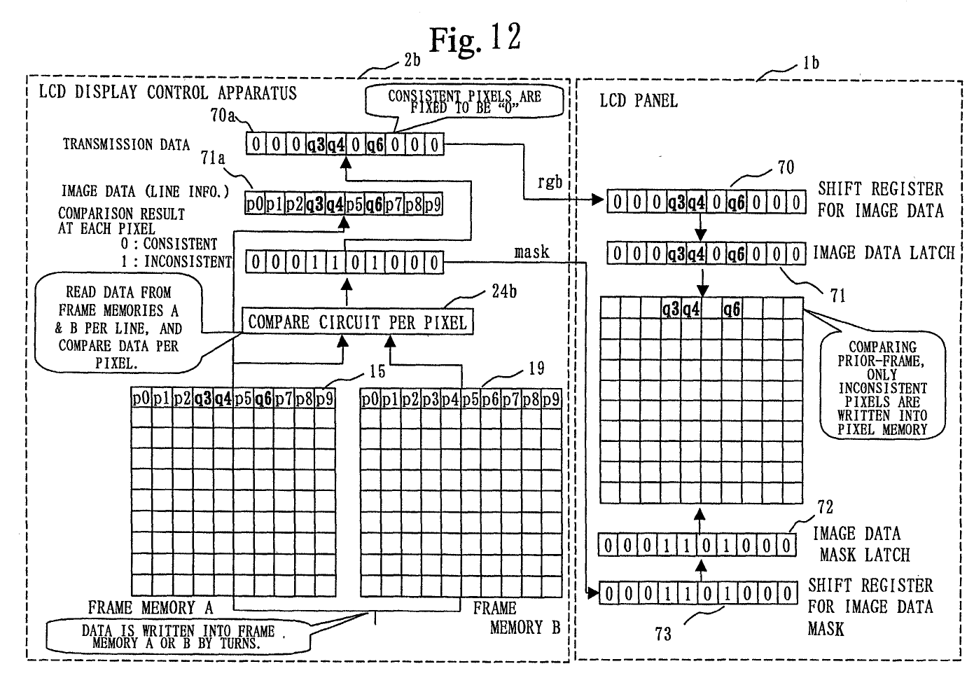

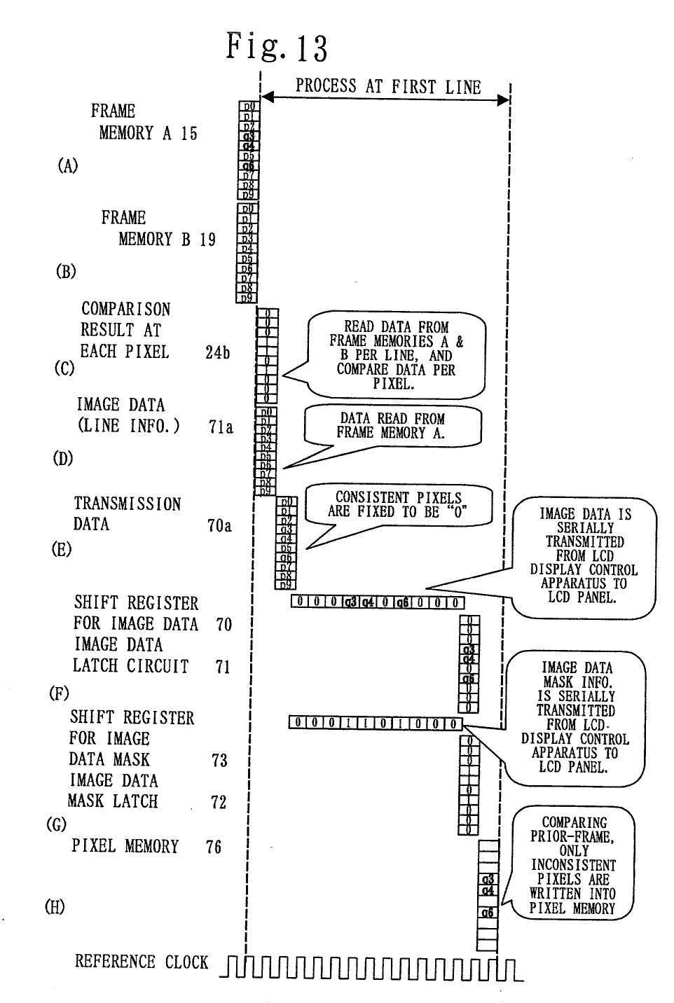

FIGS. 12 and 13 illustrate the operation of the display control apparatus according to the present Embodiment. With reference to FIGS. 12 and 13, the operation including the new element functions will be explained. In FIG. 13, it is supposed that the pixels p3, p4 and p6 in the first line of the image data in the frame memory A 15 are different from those in the first line of the image data in the frame memory B 19, and the other pixels are consistent. This inconsistency regarding the pixels p3, p4 and p6 is illustrated as the color condense difference. As shown in FIG. 13 (C), an inconsistency detection bit “1” is given to each of the three inconsistent pixels p3, p4 and p6 by the compare unit 24b. As shown in FIG. 13 (F) or FIG. 12, only the image data of the inconsistent pixels p3, p4, and p6 is transmitted from the data transmission unit 8 to the LCD panel 1, and the other pixels are fixed to be “0” indicating “unchanged”. As shown in FIG. 13 (G) or FIG. 12, the comparison result is also transmitted to the shift register 73 for image data mask. This data is respectively latched by the image data latch 71 and the shift register 73 for image data mask at the next timing. At last, only the three inconsistent pixels are written into the pixel memory 76. Since the holding control is performed per pixel subdivided from a line, not performed per line, the occasions of holding is increased, which further increases the power saving effect.

A pixel is used as the subdivided unit in the configuration of FIG. 10. In the case of color display, it is also acceptable to subdivide one line or one pixel into RGB for the purpose of detecting consistency or inconsistency by comparing the subdivided unit, that is RGB, in order to perform holding and refreshing control.

As another example of the subdividing, since a value of brightness including chroma is expressed by a plurality of bits, the value can be subdivided. For example, the value of brightness including chroma is expressed by the two (or four) bits from the top, by the two (or four) bits from the last, or by a plurality of bits.

Namely, in directing to mask an image data value per the subdivided register, the image data mask latch 27 and the transmission unit 51 for image data mask information have subdivided units expressed in the plurality of bits. Therefore, the transmission unit for image data mask information detects consistency or inconsistency per a plurality of bits or subdivided bit. Then, only inconsistent bits are written by the masking control. Accordingly, the occasions of holding control is increased, which enhances the power saving effect as much as possible. Since the comparing or writing is performed based on a subdivided value of each pixel, color, or image value register, the power consumption can be further reduced.

Embodiment 3.

Regarding a display panel with a memory function, display characteristics at the holding part become deteriorated as time passes. If refreshing is uniformly performed for such a display panel, it does not satisfy the point of power saving. Then, a new configuration for partially refreshing will now be explained.

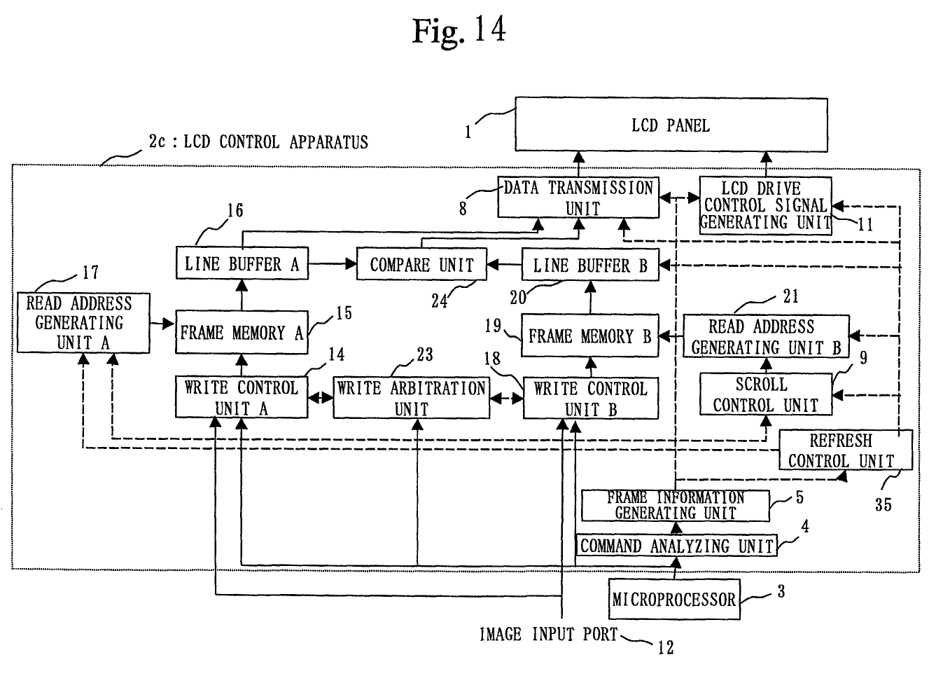

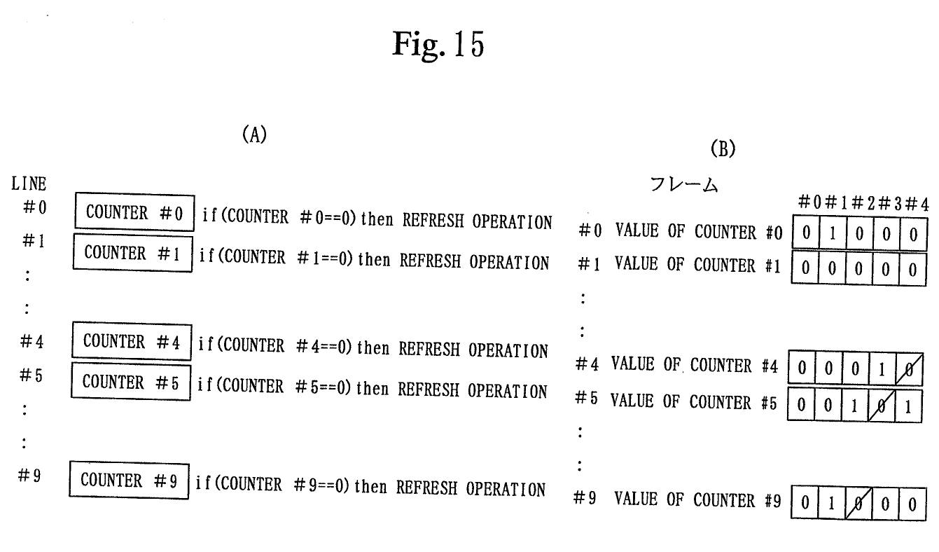

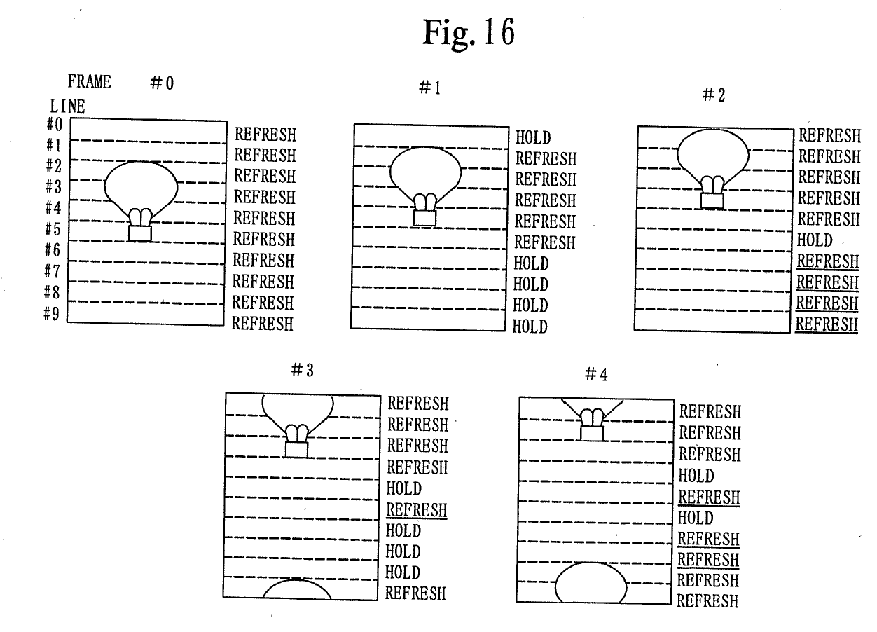

FIG. 14 shows a configuration of a display control apparatus 2c according to the present Embodiment. Comparing with Embodiment 1, a refresh control unit 35 including a counter for counting the holding times per line is provided as a new element in FIG. 14. FIG. 15 illustrates the operation of the counter in the refresh control unit 35. FIG. 16 shows a panel display example for explaining the operation of the display control apparatus according to the present Embodiment.

Now, the operation will be explained. As each pixel memory 76 in the LCD panel 2 has a configuration similar to DRAM, the memory 76 can retain data just for a specific period. Therefore, it is necessary to periodically perform refreshing in order to keep good display quality. In the present Embodiment, it is assumed that the good display quality can be kept in the holding equivalent to one frame time period. If refreshing for the whole is automatically performed in every other frame, the power consumption is increased. In the present Embodiment, the refresh control unit 35 includes a binary counter for counting successive holding times of each line. The binary counter is reset at refreshing and returned to “0” after counting “holding” twice. As shown in FIG. 15 (A), whenever the counter of each line becomes “0”, the refresh control unit 35 sends a refreshing instruction to the LCD panel 1 via the LCD drive control signal generating unit 11. Then, all the lines from #0 to #9 in the first frame are refreshed, and the counter starts counting when the counter performs holding in the next frame.

FIG. 16 illustrates a display example where the balloon is going up. This can be expressed by scrolling. The case of the background, not the balloon, at the line #9 in each of the frames #0, #1, and #2 will be described as an example. Since the line #9 has not been changed, it is enough to control to keep holding. However, it is necessary to perform refreshing at the frame #2 in order to retain good display quality. As shown in FIG. 15(B), when the binary counter counts successive holdings, it returns to “0”. Then, the refresh control unit instructs to perform refreshing.

If a ternary or quaternary counter is used instead of the binary counter, the successive holding period can be extended to be two frames or three frames. Therefore, the ternary or quaternary counter can be applied to the LCD panel of good retaining characteristic.

In the frames with the slanted lines in FIG. 15 (B), refreshing is performed in only specific lines, which realizes the power saving. In the example of FIG. 16, the lines to be originally performed refreshing are the lines from #1 to #5 in the frame #1, for instance. However, considering the holding period of the five lines from #6 to #1 as shown in the frame #1 of FIG. 16, the next refreshing for the lines from #1 to #5 can be started earlier. In other words, if the refresh control is configured to start the refreshing earlier, the number of screens can be increased in a certain period. Then, the scroll can be smoothly displayed. The refreshing is performed by way of counting the times of successive holding, which realizes the power saving and avoids the display quality deterioration.

Embodiment 4.

In the present Embodiment, will be explained a configuration aiming the power saving by contriving a refresh timing when the lines for refreshing and the lines for holding are intermingled because of scrolling or partial zooming.

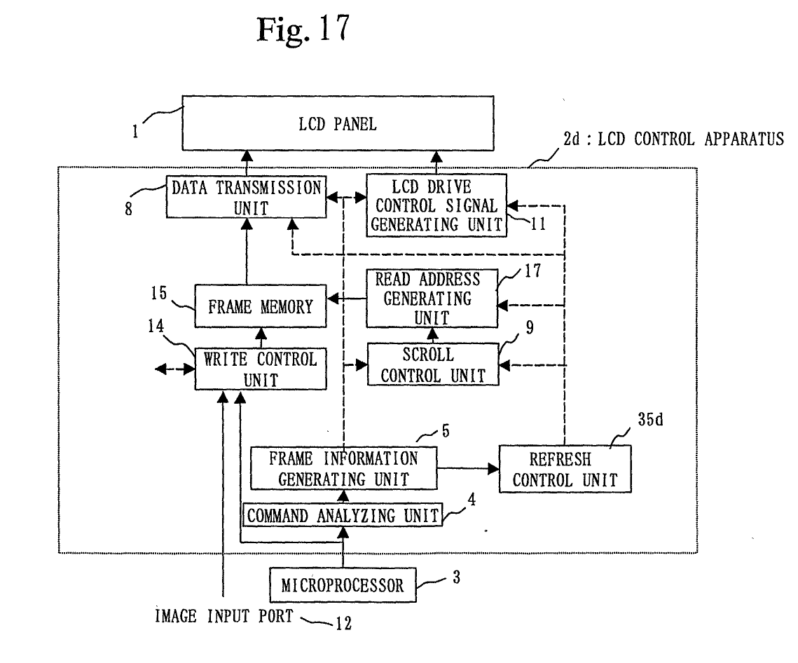

FIG. 17 shows a configuration of a display control apparatus 2d according to the present Embodiment. Comparing with Embodiment 1, a refresh control unit 35d is provided as a new element in FIG. 17. The operation of the refresh control unit 35d will be described later.

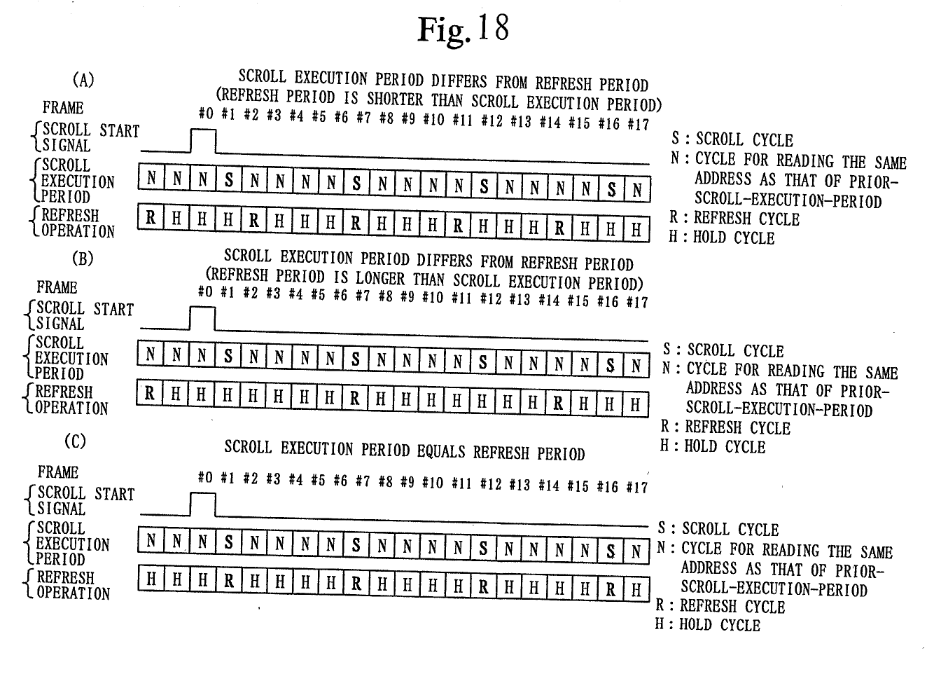

FIG. 18 illustrates a timing chart for showing the operation of the refresh control unit 35d of the present Embodiment. FIG. 18 (A) shows the case of the refresh period being shorter than the scroll period when the scrolling as shown in FIG. 16 is performed. FIG. 18 (B) shows the case of the refresh period being longer than the scroll period.

In the present Embodiment, it is conditioned that the refresh timing corresponds to the scroll timing, or either of the refreshing period and the scrolling period is set to be times of an integer, such as two times, three times and so forth, as long as the other period. Namely, the refresh control unit 35d according to the present Embodiment performs refreshing at the timings shown in FIG. 18 (C) by cooperating with the scroll control unit 9.

In the conventional case, each of the scroll control and the refresh control is respectively performed based on only a control from the microprocessor. Since there is no relation between the scroll control and the refresh control, their operation timings will be what is shown in FIG. 18 (A) or FIG. 18 (B). If the refresh period is shorter than the scroll period, the timings are shown as FIG. 18 (A). After refreshing at the frame #6, the same screen is refreshed at the frame #10. In the case of FIG. 18 (B), though the scroll instructions are given at the frames #1 and #6, refreshing is performed only at the frame #6. Therefore, not only a frame dropping but also an unnatural movement is generated as scrolling or frame dropping may happen very soon because of there being no relation between the scrolling and the refreshing.

In the present Embodiment, the scroll control unit 9 or the refresh control unit 35d notifies the updating timing, and the LCD panel drive control signal generating unit 11 is driven in order to synchronously perform the scrolling and the refreshing. As a synchronization example, a control unit for refresh timing or scroll timing is configured to have a spare time before outputting an AND signal.

The case of scrolling has been explained above. It is also acceptable to apply the synchronization to the screen display zooming by using the zoom control unit 13 of FIG. 8. Namely, the essential point is that a calculation control unit performs a specific calculation to obtain a frame memory based on an instruction from the microprocessor 3 being synchronized with the refreshing.

In each of the above Embodiments, the LCD control apparatus is configured to have two frame memories, and to perform comparing per line after alternatively writing image data into the previous frame and the current frame. However, if operations follow one after another, it is not necessary to have two frame memories. For example, in the configuration where a plurality of line buffers are provided to circularly rewrite image data per line in turn, only the image data of inconsistent line is written into the frame memory and the image data of consistent line is not stored. By dint of this configuration, the frame memory amount can be reduced. Regarding the configuration elements referred to in the explanation for each configuration or operation, it is acceptable to compose them by hardware. It is also acceptable to have a method of configuring them by software having steps including functions of a general microprocessor and a memory. As the refreshing times for the parts necessary to be calculated such as the part of zooming is reduced, the power consumption can be reduced.

Having thus described several particular embodiments of the invention, various alterations, modifications, and improvements will readily occur to those skilled in the art. Such alterations, modifications, and improvements are intended to be part of this disclosure, and are intended to be within the spirit and scope of the invention. Accordingly, the foregoing description is by way of example only, and not intended to be limiting. The invention is limited only as defined in the following claims and the equivalents thereto.

What is claimed is:

1. A display control apparatus, which refreshes image data in a frame memory of a display panel with a memory function, comprising:
a compare unit for comparing the image data in a previous frame and the image data in a current frame at a specific line in the display panel;
a data transmission unit for transmitting the image data in the current frame at the specific line in order to update the image data when the compare unit outputs inconsistency at the specific line as a comparing result, and for transmitting hold information when the compare unit outputs consistency at the specific line; and
a display panel drive control unit for synchronously giving an instruction of refreshing (display writing) with the transmitting of the data transmission unit,
wherein the display panel performs refreshing by the instruction from the display panel drive control unit based on the image data from the data transmission unit.

2. The display control apparatus of claim 1 further comprising:
a mask latch register for masking a pixel where image data writing is to be stopped; and
an image data mask information transmission unit for giving an instruction, to the mask latch register, of masking a pixel in the image data at the specific line in the current frame when the pixel has the same image data as the previous frame,
wherein the display panel performs display writing based on the mask latch register.

3. The display control apparatus of claim 2, wherein the mask latch register and the image data mask information transmission unit perform giving an instructing of masking and holding per color of RGB.

4. The display control apparatus of claim 2, wherein the mask latch register and the image data mask information transmission unit perform giving an instruction of masking and holding per image value register subdivided from an image data value.

5. The display control apparatus of claim 1 further comprising a counter for counting successive holding times per line, and a refresh control unit for giving an instruction of refreshing (display writing) of the display panel,
wherein the refresh control unit gives the instruction of refreshing of a line which is originally to be performed holding, when the successive holding times has become over a predefined value.

6. The display control apparatus of claim 1 further comprising:
a calculation control unit for performing a specific calculation against a line to be performed image data updating, based on an instruction from a microprocessor in order to obtain an address of the frame memory; and
a refresh control unit for instructing refreshing a line, wherein the calculation control unit and the refresh control unit give instructions to the display panel at a synchronous timing.

7. A display control method, for refreshing image data in a frame memory of a display panel with a memory function, comprising:
comparing the image data in a previous frame and the image data in a current frame at a specific line in the display panel;
transmitting the image data in the current frame at the specific line in order to update the image data when the comparing results in inconsistency at the specific line, and transmitting hold information when the comparing results in consistency at the specific line; and
synchronously giving an instruction of refreshing (display writing) with the transmitting the image data,
wherein the display panel performs refreshing the image data in the transmitting, based on the instruction.

8. The display control method of claim 7 including a mask latch register for masking a pixel where image data writing is to be stopped, further comprising:
giving an instruction, to the mask latch register, of masking a pixel in the image data at the specific line in the current frame when the pixel has the same image data as the previous frame,
wherein the display panel performs display writing based on the mask latch register.

9. The display control method of claim 8, wherein the mask latch register retains a mask value per color of RGB, comprising:
transmitting the mask value per color of RGB in the giving the instruction.

10. The display control method of claim 7 further comprising:
counting successive holding times per line; and
giving an instruction of refreshing of a line which is originally to be performed holding, when the successive holding times has become over a predefined value.
